(19) United States
(12) Patent Application Publication
(10) Pub. No.: US 2023/0307725 A1
(43) Pub. Date: Sep. 28, 2023

(54) BATTERY MODULE INCLUDING A CIRCUIT TO CONTROL THE STATE OF THE BATTERY MODULE

(71) Applicant: CPS Technology Holdings LLC, New York, NY (US)

(72) Inventor: Ronald J. Dulle, Mequon, WI (US)

(21) Appl. No.: 18/020,233

(22) PCT Filed: Aug. 10, 2021
(86) PCT No.: PCT/US2021/045356

§ 371 Date: Feb. 7, 2023

Related U.S. Application Data
(60) Provisional application No. 63/064,050, filed on Aug. 11, 2020.

(51) Int. Cl. H01M 10/42; H01M 50/569; H01M 50/543; H01M 10/0525

(52) U.S. Cl. CPC H01M 10/4257; H01M 50/569; H01M 50/543; H01M 10/0525; H01M 2010/4271; H01M 2220/20

(57) ABSTRACT

A battery module is disclosed. In one implementation, the battery module comprises a housing having a terminal, an electrochemical cell in the housing, a relay controlling a current available from the electrochemical cell to the terminal, and a relay driver and control. The relay driver and control provides a first current to the relay coil to change a state of the relay from an open state to a closed state. The current source further provides a second current to the relay coil to maintain the state of the relay in a closed state. A parameter of the second current is different from the parameter of the first current. Also disclosed are methods of operating the battery module.

### BACKGROUND

This application relates to the field of battery modules.

A vehicle may include one or more battery modules (or batteries). For example, a vehicle may include a first conventional twelve-volt (12V) lead-acid battery and a second forty-eight-volt (48V) battery module. The 48V battery module can include lithium-ion (li-ion) battery cells and a battery management system (BMS) controlling the battery module.

The 48V battery module can include a module on/off relay and a relay driver for driving the on/off relay. The relay can control whether power is available at the terminals of the battery module. When driving a relay coil of the relay, the energy required to close the relay is much higher than the energy required to keep it closed. A switching regulator can be used to control relay excitation by varying the voltage applied to the relay. However, switching the relay coil in a 48V module can create significant electromagnetic compatibility (EMC) issues. Further, overdriving the relay coil with a constant voltage can increase heat in the relay coil, resulting in wasted energy and increased relay failure.

Another alternative solution addressing one or more of the above deficiencies or other deficiencies is desired.

### SUMMARY

A battery module having a module on/off relay and a relay driver are disclosed herein. Rather than providing a switched pulse-width-modulated (PWM) voltage or a continuous over-drive voltage, the relay driver includes a variable current source to drive a direct current (DC) (or DC signal) into the relay coil. The use of the DC signal drastically improves the EMC over known prior battery modules.

In one operation, a first current is applied by the relay driver to the relay coil for transitioning the relay from an open state to a closed state. After the relay transitions, the drive current is updated to a second current for ensuring the relay maintains the closed state. This minimizes power dissipation by revising the current. The decision when to perform the updated drive current can be based on a time period or on current feedback. By having the output of the relay driver be programable, the system can reduce power dissipation, adjust for circuit and coil characteristics (such as temperature variation), allow for smaller components, and reduce the bill of materials.

In another embodiment, a battery module is disclosed. The battery module comprises a housing having a terminal, an electrochemical cell in the housing, a relay controlling a current available from the electrochemical cell to the terminal, and a relay driver and control. The relay driver and control provides a first current to the relay coil to change a state of the relay from an open state to a closed state. The current source further provides a second current to the relay coil to maintain the state of the relay in a closed state. A parameter of the second current is different from the parameter of the first current.

In yet another embodiment, a method of controlling a battery module is disclosed. The battery module includes an electrochemical cell, a terminal, and a relay controlling a current available from the electrochemical cell to the terminal. The relay includes a relay coil. The method comprises providing a first direct current (DC) to the relay coil to change a state of the relay from an open state to a closed state and providing a second direct current (DC) to the relay coil to maintain the state of the relay in the closed state. The closed state allows a power to be made available at the terminal and the open state prevents power from being available to the terminal. The parameter of the second DC is different from a parameter of the first DC.

These and various further advantages may be understood from the disclosure herein.

### BRIEF DESCRIPTION OF THE DRAWINGS

FIG. 1 is a cutaway schematic view of portions of a vehicle.

FIG. 2 is a block diagram of an example battery module used in the vehicle of FIG. 1.

FIG. 3 is a block diagram of an example relay and driver control used in the battery module of FIG. 2.

FIG. 4 is an electrical schematic of the relay and driver control of FIG. 3.

It should be understood that the drawings are not necessarily to scale. In certain instances, details that are not necessary to the understanding to the invention or render other details difficult to perceive may have been omitted. It should be understood, of course, that the invention is not necessarily limited to the apparatus or processes illustrated herein.

### DETAILED DESCRIPTION

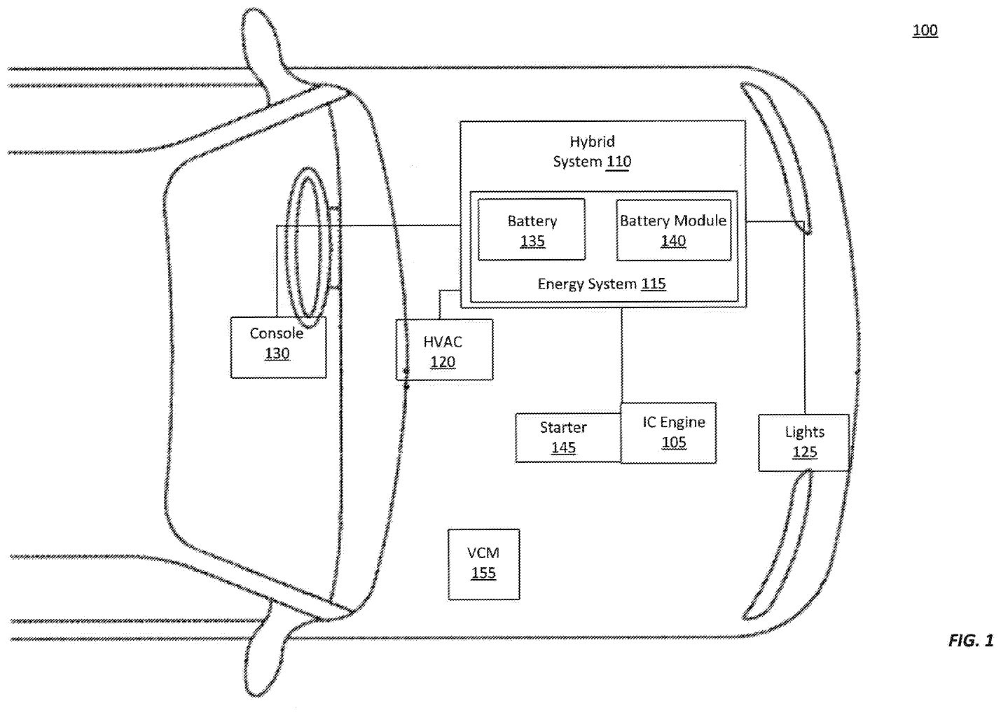

FIG. 1 illustrates a cutaway schematic view of a vehicle 100 in the form of an automobile. For the shown construction, the vehicle 100 includes an internal combustion engine 105 coupled with a hybrid system 110. The example hybrid system 110 used for FIG. 1 is referred to as a micro-hybrid system having a start-stop system. The hybrid system 110 may utilize an energy storage system 115 to power at least one or more accessories (e.g., a heating, ventilation, and air conditioning (HVAC) system 120, lights 125, console 130, etc.), as well as the ignition of the engine 105 during start-stop cycles. The engine and/or the energy storage system 115 provide all or a portion of the power (e.g., electrical power and/or motive power) for the vehicle 100. The vehicle 100 may be one of many types including a truck, bus, industrial vehicle, motorcycle, recreational vehicle, boat, or another type of vehicle that may benefit from the use of electric power. The hybrid system can be of a different type or by an all-electric system. Additionally, one or more aspects of the invention may be used in other non-vehicle environments having an energy storage system.

For the shown construction, the energy storage system 115 includes a first battery module (or battery) 135 (e.g., a twelve-volt (12V) lead-acid battery) and a second battery module (or battery) 140 (e.g., a forty-eight-volt (48V) li-ion battery module). The battery 135 can, for example, supply energy to ignite or start the engine 105 and/or support conventional 12V accessory loads. The battery module 140 can, for example, supply energy to power one or more vehicle accessories when the engine 105 is not running, and for use in the hybrid system 110. The battery module 140 can also provide a second or supplemental 12V output. The battery module 140 can further provide other voltage outputs, including voltages between approximately 3.5V to 60V (e.g., 6V, 12V, 24V, 36V, 48V, and 56V).

The battery module 140 may be coupled to a starter 145, which may be used to start the engine 105 during a start-stop cycle, and the 12V output of the battery 135 may be coupled to a traditional ignition system to start the engine 105 during instances when the starter 145 is not used to do so. It should also be understood that the starter 145 may also capture energy from a regenerative braking system or the like (not shown) to recharge the battery module 140.

The battery module 140 may be used to power one or more accessories of the vehicle 100. For example, the battery module 140 may be coupled to the HVAC system 120 (e.g., including compressors, heating coils, fans, pumps, and so forth) of the vehicle 100 to enable the driver to control the temperature of the interior of the vehicle 100 during operation of the vehicle 100. This is more important, for example, in a micro-hybrid electric vehicle during idle periods when the engine 105 is stopped and, thus, not providing any electrical power via engine charging. As also illustrated, the battery module 140 may be coupled to a vehicle console 130, which may include entertainment systems (e.g., radio, CD/DVD players, viewing screens, etc.), warning lights and indicators, controls for operating the vehicle 100, and so forth. Hence, it should be appreciated that the voltage output of the battery module 140 may, in certain situations, provide a more efficient voltage at which to operate the accessories of the vehicle 100 (e.g., compared to the battery 135), especially when the engine 105 is stopped (e.g., during start-stop cycles). It should also be appreciated that, in certain constructions, the battery module output may also be provided to other suitable components and/or accessories (e.g., lights, switches, door locks, window motors, windshield wipers, and so forth) of the vehicle 100.

The illustrated vehicle 100 includes a vehicle control module (VCM) 155 that controls one or more operational parameters of the various components of the vehicle 100. The vehicle control module 155 may include at least one memory and at least one processor programmed to perform such tasks. Like other components of the vehicle 100, the battery module 140 may be coupled to the vehicle control module 155 via one or more communication lines, such that the vehicle control module 155 may receive input from and provide output to the battery module 140, and more specifically, the battery management system (discussed below) of the battery module 140. For example, the vehicle control module 155 may receive input from the battery module 140 regarding various parameters, such as state of charge and temperature, and the vehicle control module 155 may use these inputs to determine when to charge and/or discharge the battery module 140, when to discontinue charging/discharging the battery module 140, when to start and stop the engine 105, and so forth.

It should be noted that, in other constructions, other types of vehicles and configurations for the vehicle drive system and energy storage system may be utilized, and that the schematic illustration of FIG. 1 should not be considered to limit the scope of the subject matter described in the present application. According to various embodiments, the size, shape, and location of the battery system, the type of vehicle, the type of hybrid (xEV) technology, and the battery chemistry, battery voltage, battery capacity, among other features, may differ from those shown or described herein.

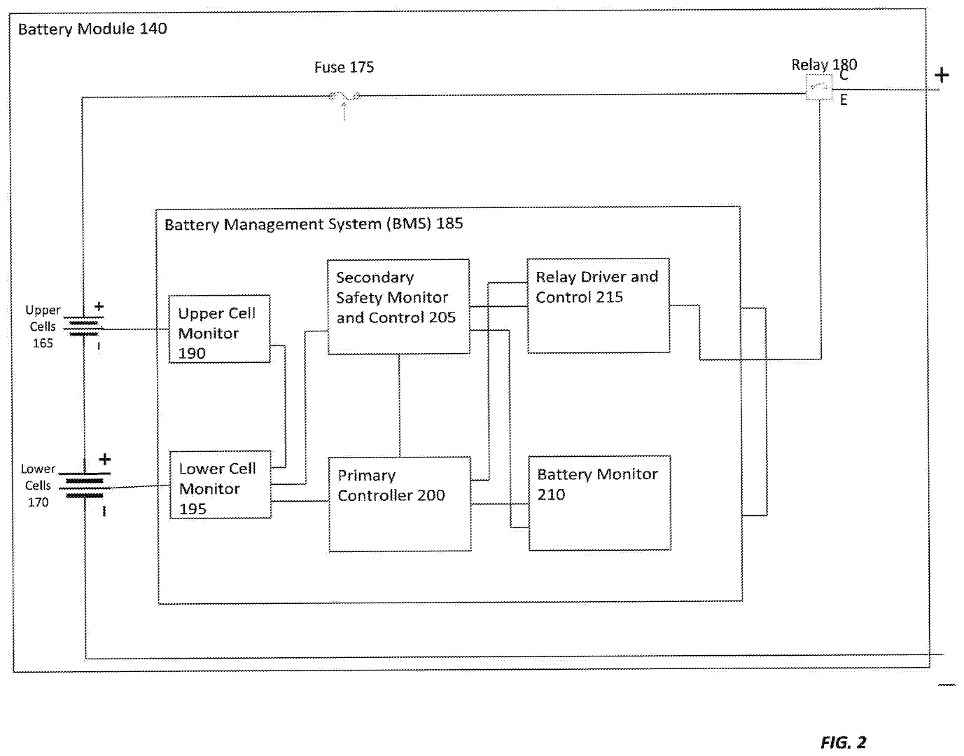

FIG. 2 is a block diagram showing portions of a battery module 140 to package, connect, and regulate electrochemical cells 165 and 170. The battery module 140 includes a number of electrochemical cells 165 and 170, a fuse 175, a relay 180, and the battery management system 185. The battery module 140 includes other components, elements, and circuits known in the art but not shown or described herein for simplicity. As a simple example, the battery module 140 may include a thermal management system, which is well known in the art.

The electrochemical cells shown in FIG. 2 include a first series of electrochemical cells 165 and a second series of electrochemical cells 170. The cells 165 and 170 can be lithium-ion cells and are configured to store an electrical charge. The number of cells, the number of series, the size and shape of the cells, the chemistry of the cells, etc., can vary as known in the art. The fuse 175 is an electrical safety device that interrupts the circuit when a current through the fuse exceeds an amperage. The relay 180 provides for control (makes/breaks) of current to loads connected to the battery module 140. The triggering of the relay 180 is controlled by a signal provided by the battery management system 185. The battery management system 185 regulates the current, voltage, and/or temperature of the cells 165/170 in the battery module 140.

For the diagram in FIG. 2, the battery management system 185 includes an upper cell monitor 190, a lower cell monitor 195, a primary control 200, a secondary safety monitor and control 205, a battery monitor 210, and a relay driver and control 215. The shown battery module 140 includes the upper and lower battery electrochemical cells 165 and 170. Similarly, the shown battery module 140 includes an upper cell monitor 190 and a lower cell monitor 195. The upper/lower cell monitors 190/195 include circuitry for cell voltage monitoring, cell balancing, pack voltage monitoring, and cell temperature sensing, among other sensed parameters. For the shown construction, the upper cell monitor 190 communicates the monitored parameters to the lower cell monitor 195, which provides communication for both cell monitors 190 and 195 to the primary control 200 and the secondary safety monitor and control 205. The number, blocks, and arrangements for the cells and the number of cell monitors can vary from what is shown in FIG. 2 based on many factors.

The battery monitor 210 includes circuitry for monitoring a primary current, a primary bus voltage, a secondary pack voltage, and a pack temperature, among other parameters. The battery monitor 210 communicates the monitored parameters to the primary controller 200 and the secondary safety monitor and control 205.

The secondary safety monitor and control 205 provides a second or redundant monitor and control in case the various monitors and the primary controller fail. The secondary safety monitor and control 205 can also provide a control signal for the relay driver and control 215 in response to a command from the primary controller 200.

Before proceeding to the primary controller 200 and the relay driver and control 215, it should be understood that the battery management system 185 includes other circuitry for performing other functions. For example, the battery management system 185 can include other circuits for providing a system power supply, internal pack communication (e.g., via a controller area network (CAN) bus), external pack communication, other sensors (e.g., a crash sensor), auxiliary contact status, conditioning circuits, other driver circuits, etc. Further discussion regarding these elements is not discussed further as they are commonly known in the art.

The primary controller 200, which may also be referred to as the MCU in the art, includes circuitry for performing the primary monitoring of battery module parameters, vehicle interfacing, and controlling the relay 180 via the relay driver and control 215. The controlling of the relay 180 by the primary controller 200 can also be via the secondary safety monitor control (or secondary MCU) 205. For example, if the output of the primary controller 200 is a first control signal, the secondary safety monitor and control 205 can check additional safety parameters before translating and forwarding the control signal to the relay driver and control 215. Alternatively, the primary controller 200 can directly control the relay driver and control 215. Moreover, it is envisioned that yet other possible control schemes known to those skilled in the art can be used to control the relay driver and control 215.

The primary controller 200 can include a processor and memory. The processor can include a component or group of components that are configured to execute, implement, and/or perform any of the processes or functions described herein for the battery module or a form of instructions to carry out such processes or cause such processes to be performed. Examples of suitable processors include a microprocessor, a microcontroller, and other circuitry that can execute software. Further examples of suitable processors include, but are not limited to, a core processor, a central processing unit (CPU), a graphical processing unit (GPU), an array processor, a vector processor, a digital signal processor (DSP), a field-programmable gate array (FPGA), a programmable logic array (PLA), an application specific integrated circuit (ASIC), math co-processors, and programmable logic circuitry. The processor can include a hardware circuit (e.g., an integrated circuit) configured to carry out instructions contained in program code. In arrangements in which there are a plurality of processors, such processors can work independently from each other or one or more processors can work in combination with each other.

The primary controller 200 includes a memory for storing one or more types of instructions and/or data. The memory can include volatile and/or non-volatile memory. Examples of suitable memory include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, disks, drives, or any other suitable storage medium, or any combination thereof. The memory can be a component of the processor, can be operatively connected to the processor for use thereby, or a combination of both.

In one or more arrangements, the memory can include various instructions stored thereon. For example, the memory can store one or more modules. Modules can be or include computer-readable instructions that, when executed by the processor, cause the processor to perform the various functions disclosed for the module. While functions may be described herein for purposes of brevity, it is noted that the functions for the mobile electronic device are performed by the processor using the instructions stored on or included in the various modules. Some modules may be stored remotely and accessible by the processor using, for instance, various communication devices and protocols.

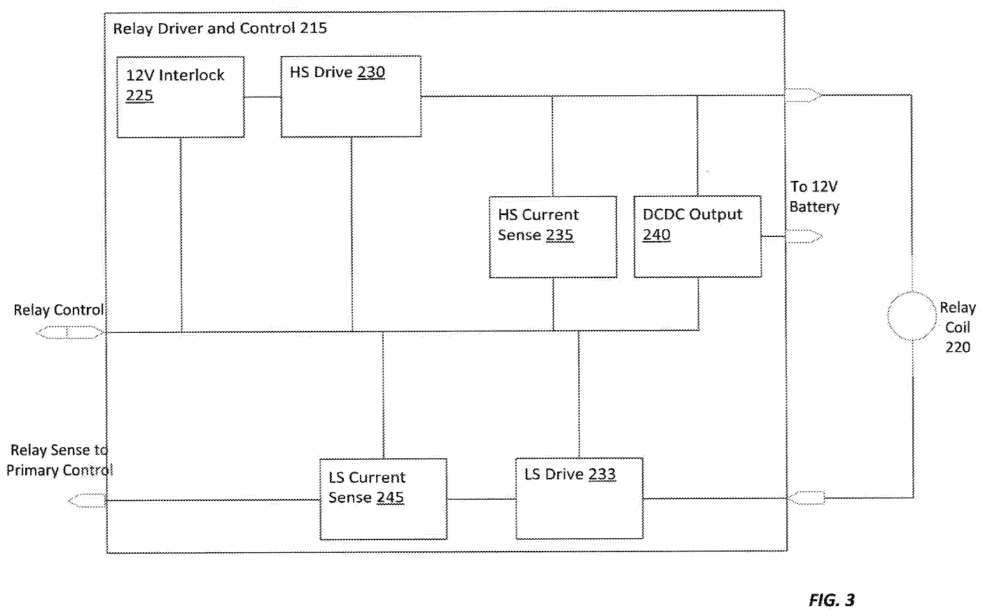

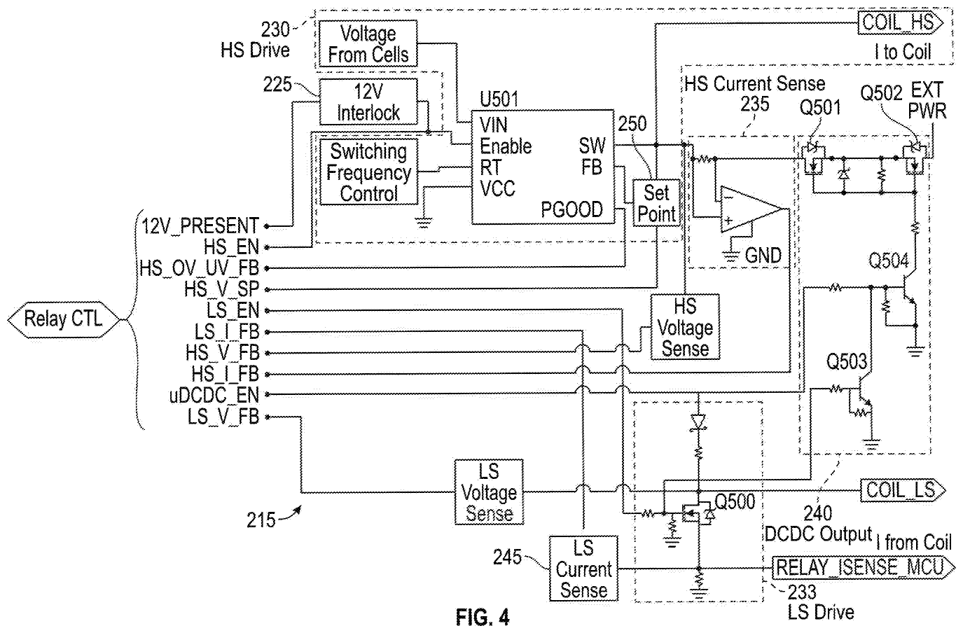

Further details regarding the relay driver and control 215 are schematically represented in FIGS. 3 and 4. The relay driver and control 215 communicates with the primary controller 200 and the secondary safety monitor and control 205, either directly or indirectly, using a relay control signal. The relay control signal can be a series of signals, including a 12V-present signal, a high-side enable signal, a high-side over/under voltage feedback signal, a high-side voltage setpoint signal, a low-side enable signal, a low-side current feedback signal, a high-side voltage feedback signal, a high side current feedback signal, a DCDC enable signal, and a low-side voltage feedback signal. The relay driver and control 215 can also provide a current sense signal to the primary controller 200. An explanation of the signals is as follows in Table T1.

TABLE T1

| Signal | Abbreviation | Explanation |
|---|---|---|
| 12 V-present signal | 12 V_PRESENT | Provides a signal to the 12 V interlock indicating that |
| | | a 12 V signal is present from the battery 135. |
| high-side enable | HS_EN | Provides a signal enabling the regulator U501, which |
| signal | | enables/disables the high side drive 230. |
| high-side over/under | HS_OV_UV_FB | A feedback signal from the regulator U501 indicating |
| voltage feedback | | if there is an over voltage or under voltage detection |
| signal | | error on the high-side supply. For example, the |
| | | signal can indicate a short to battery or ground on |
| | | the high-side coil or detect a regulation issue. |
| high-side voltage | HS_V_SP | Provides a signal to the setpoint circuit of the high |
| setpoint | | side drive 230. The signal results in the high side |
| | | drive providing a current at a set voltage. |
| low-side enable | LS_EN | Provides a signal enabling the switch Q500 of a low |
| signal | | side drive 233, which enables/disables a current |
| | | through the low-side return of the coil to ground. |
| | | The signal also disables/enables transistor Q503 to |
| | | help enable/disable the DCDC output 240. |
| low-side current | LS_I_FB | A feedback signal from the low side current sense |
| feedback signal | | 245 indicating a current value for the low side |
| | | circuit. |
| high-side voltage | HS_V_FB | A feedback signal from the high side drive 230 |
| feedback signal | | indicating a voltage value for the high side voltage. |
| high-side current | HS_I_FB | A feedback signal from the high side current sense |
| feedback signal | | 235 indicating a current value for the high side |
| | | circuit. |
| DCDC enable signal | uDCDC_EN | Provides a signal enabling the switch Q504, which |
| | | helps enable/disable the DCDC output 240. |
| low-side voltage | LS_V_FB | A feedback signal from the low side coil return |
| feedback signal | | providing a voltage value. |

The relay driver and control 215 can drive a current through relay coil 220. The relay coil 220 controls the switch or contactor of the relay 180, thereby making or breaking the current through the relay 180. The relay driver and control 215 can also drive or provide a current to the battery 135 to charge the battery 135 with energy from the battery module 140.

The relay driver and control 215 includes a 12 V interlock 225, a high-side (HS) drive 230, a low-side (LS) drive 233, a high-side (HS) current sense 235, a DCDC output 240, and a low-side (LS) current sense 245.

The 12V interlock 225 receives the 12V-present signal from the battery 135. If the battery 135 is not connected to 12V-present signal, then the relay 180 will not operate since the 12V-present signal will not the enable regulator U501. Accordingly, the circuit of block 225 acts as a 12V interlock.

The HS drive 230 receives enable signals from the high-side enable and the 12V interlock 225. The enable signals enable the regulator U501. The regulator U501 can be a synchronous step-down DC-DC converter capable of driving up to 2 A, for example, of load current from an input voltage ranging from 3.5 V to 60 V, for example. The power for the HS drive 230 originates from the electrochemical cells 165 and 170. The block labeled set point 250 (in FIG. 4) sets the value of the output voltage of the regulator U501, and which also effectively sets the current provided by the high-side drive 230 (as discussed below). The output voltage of the regulator U501 can be hardwired limited (e.g., 14V). The output current of the HS drive 230 is provided to the relay coil 220, HS current sense 235. Based on enable signals, the output of the HS drive 230 is to power either the relay coil 220 or the DCDC output 240. The regulator U501 can also be frequency controlled, which may be set to a frequency of zero.

The HS current sense 235 for the DCDC output 240 provides a current value from the HS drive 230, particularly when the DCDC converter 240 is active and a current is provided through the DCDC output 240. When a current is not provided through the DCDC output 240, and is instead provided to the relay coil 220, then the low-side current sense 245 measures the current. Using the value of the HS current sense 235, the current resulting from the DCDC output 240 can be monitored.

The DCDC output 240, which can be a microcircuit, and hence be a microDCDC (uDCDC output), is used to trickle energy to the 12V battery 135 from the 48V battery module 140 so that the 12V battery 135 maintains a full charge. Typically, a 12V lead-acid battery 135 prefers to remain fully charge, particularly when the 12V battery starts the internal combustion engine 105. The DCDC output 240 can be active when the current is not being provided to the relay coil 220.

The LS current sense 245 senses a current from the low side of the relay coil 220 to ground. Using the value of the LS current sense 245, the current resulting from the HS drive 230 through the relay coil 220 can be controlled.

Before proceeding to an example operation, it should be understood that the relay driver and control 215 includes other circuitry for performing other functions. For example, the relay driver and control 215 can include other conditioning circuits, protection circuits, supplies, comparators, regulators, etc. Further discussion regarding these elements is not discussed further as they are commonly known in the art.

In operation, the HS drive 230 can drive either the relay coil 220 or the DCDC output 240 based on enable signals. The high side current sense 235 and the low side current sense 245 provide a current feedback value depending upon whether the DCDC output 240 is enabled or the relay coil 220 is enabled. More specifically, the high side current sense 235 is enabled when the DCDC output 240 is enabled, and the low side current sense 245 is enabled when the relay coil 220 is enabled.

When the HS drive 230 is active, the set point circuit 250 sets a value of the voltage provided by the regulator u501. In the case of when the DCDC output 240 is enabled, the set point circuit 250 can limit the amount of current (or energy) available to the battery 135 while charging. For example, the regulator u501 may provide an initial voltage of 12.3V. The HS current sense 235 can monitor the current resulting from the voltage, e.g 12.3V, and the primary controller 200, for example, can use that monitored current to adjust the voltage. For example, if the current is above a maximum current (e.g., 1 A), the primary controller 200 can lower the voltage. Alternatively, if the current is below the maximum current (e.g., 1 A), the primary controller 200 can raise the set-point voltage until it reaches a maximum voltage (e.g. 13.5V). The HS drive 230 can continue to charge the battery 135 for a defined time period, until a defined voltage is sensed or set, or until a defined voltage and current are sensed.

In the case of when the relay coil is enabled, the set point circuit 250 can control the output of the regulator U500 such that it acts as a current source. For example, the regulator u501 may provide an initial voltage. The initial voltage is set at a known voltage (e.g., 5V) for a known time period (e.g., 100 ms) sufficient to drive the relay coil 220 resulting in the relay 180 closing. The value of the current needed to close the relay 180 is typically much larger than the value of the current needed to maintain the relay 180 close. After this initial time period, the primary controller 200 can begin to monitor the value of the LS current sense 245 and adjust the value of the set point circuit to maintain a current value to keep the relay 180 closed. Over time, the value of the set point circuit may need to be adjusted to keep the current value constant. This optimizes the power draw, reduces overdriving the relay coil 220, generates less heat in the relay coil, and reduces wear on the relay 180.

Accordingly, the disclosure provides a new and useful battery module having a multi-function relay driver. The disclosure also provides a new and useful battery module having a circuit to control the state of the battery module.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

Some of the systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. Some of the systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the maintenance conditions enabling the implementation of the methods described herein and which, when loaded in a processing system, is able to carry out these methods.

Furthermore, some arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or a suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

For the purpose of this disclosure, the terms “coupled” and “connected” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

The terms fixedly, non-fixedly, and removably, and variations thereof, may be used herein. The term fix, and variations thereof, refer to making firm, stable, or stationary. It should be understood, though, that fixed doesn't necessarily mean permanent-rather, only that a significant or abnormal amount of work needs to be used to make unfixed. The term removably, and variations thereof, refer to readily changing the location, position, station. Removably is meant to be the antonym of fixedly herein. Alternatively, the term non-fixedly can be used to be the antonym of fixedly.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A battery module comprising:
a housing having a terminal;
an electrochemical cell in the housing;
a relay controlling a current available from the electrochemical cell to the terminal, the relay including a relay coil to control a state of the relay; and
a relay driver and control to provide
a first direct current (DC) to the relay coil to change the state of the relay from an open state to a closed state, and
a second direct current (DC) to the relay coil to maintain the state of the relay in the closed state, a parameter of the second DC being different from a parameter of the first DC.

2. The battery module of claim 1, wherein the closed state makes power available to the terminal, and the open state prevents power from being available to the terminal.

3. The battery module of claim 1, wherein the relay driver and control comprises:
a set point circuit providing a setpoint; and
a regulator that receives a voltage from the electrochemical cell and the set point from the set point circuit, and controls an output of the regulator to provide the first DC and the second DC.

4. The battery module of claim 3, wherein the regulator is a synchronous step-down DC-DC converter.

5. The battery module of claim 3, further comprising a controller coupled to the relay driver and control, the controller being configured to
control the relay driver and control to provide the first DC for a time period, and
control the relay driver and control to provide the second DC after the time period.

6. The battery module of claim 5, wherein the relay driver and control includes a current sensor, and wherein the controller is further configured to
monitor a value of the current sensed by the current sensor, and
adjust the set point circuit to maintain a current value to keep the relay closed.

7. The battery module of claim 1, wherein the electrochemical cell includes a lithium-ion based chemistry.

8. The battery module of claim 1, wherein the parameter of the second DC includes a voltage less than the parameter of the first DC.

9. A method of controlling a battery module having an electrochemical cell, a terminal and a relay controlling a current available from the electrochemical cell to the terminal, the relay including a relay coil, the method comprising
providing a first direct current (DC) to the relay coil to change a state of the relay from an open state to a closed state, the closed state to allow a power to be made available at the terminal and the open state to prevent power from being available to the terminal; and
providing a second direct current (DC) to the relay coil to maintain the state of the relay in the closed state, a parameter of the second DC being different from a parameter of the first DC.

10. The method of claim 9, wherein the first DC is provided for a time period, and the second DC is provided after the time period.

11. The method of claim 9, and further comprising:
sensing a current related to the second DC;
monitoring a value of the current; and
adjusting a voltage of the second DC based on the monitored value.

12. The method of claim 9, wherein the parameter of the second DC includes a voltage less than the parameter of the first DC.
